(19) United States
(12) Patent Application Publication
(10) Pub. No.: US 2024/0189723 A1
(43) Pub. Date: Jun. 13, 2024

(54) VIDEO GAME GROUP DYNAMIC BUILDING

(71) Applicant: Activision Publishing, Inc., Santa Monica, CA (US)

(72) Inventors: Josiah Eatedali, Los Angeles, CA (US); Robert Schonfeld, Sherman Oaks, CA (US)

(73) Assignee: ACTIVISION PUBLISHING, INC., Santa Monica, CA (US)

(21) Appl. No.: 18/357,940

(22) Filed: Jul. 24, 2023

Related U.S. Application Data
(63) Continuation of application No. 15/960,344, filed on Apr. 23, 2018, now abandoned.
(60) Provisional application No. 62/610,797, filed on Dec. 27, 2017.

(51) Int. Cl. A63F 13/86; A63F 13/35; A63F 13/355; A63F 13/46; A63F 13/63; A63F 13/69; A63F 13/79; A63F 13/792

(52) U.S. Cl. CPC A63F 13/86; A63F 13/35; A63F 13/355; A63F 13/46; A63F 13/63; A63F 13/69; A63F 13/79; A63F 13/792

(57) ABSTRACT

Monitoring of video game play and of streaming of video game play is performed, and rewards are provided based on occurrence of events during video game play.

### CROSS REFERENCE TO RELATED APPLICATION

This application claims the benefit of the filing date of U.S. Provisional Patent Application No. 62/610,797, filed on Dec. 27, 2017, the disclosure of which is incorporated by reference herein.

### BACKGROUND OF THE INVENTION

The present invention relates generally to video games, and more particularly to event driven video game related reward actions.

Video games provide fun and enjoyment for many. Video games allow users to participate in a variety of simulated activities. Video games allow users to perform roles and experience activities that the users may not be able or desire to experience directly, whether due to cost, danger, or equipment concerns, or simply due to a role or activity being a fantasy.

In some cases, playing of video games can be a solitary experience, with for example a single game player playing a video game, on their own. In other cases video game play may include multiple players, but the multiple players may not know one another, and may not particularly care or have an interest in when other players achieve accomplishments in the video game, particularly when not then engaged in video game play with or against those players. This possible lack of engagement with other game players may detract from video game play, or a desire to engage in video game play. Unfortunately, encouraging others to take interest in the video game accomplishments of a game player may be difficult.

Game players may also tend towards playing a particular game, or a single game play pattern of a particular game, perhaps repeatedly, and perhaps to the exclusion of other games or game play patterns, which may broaden experiences of the game player. In some cases, however, the game player may merely not know of the opportunities presented by other games or game play patterns, even though other game players may have such knowledge. Those games and game play patterns may be ones that the game player would also enjoy, if only someone would introduce the game play pattern to the game player. Unfortunately, encouraging individuals to share play of video games may be difficult.

### BRIEF SUMMARY OF THE INVENTION

Some embodiments in accordance with aspects of the invention relate to rewarding individuals who promote play of a video game. In some such embodiments, a measure of rewards is based on a measure of proficiency in play of the video game, with in some embodiments the measure relating to proficiency of an individual promoting the video game and in some embodiments the measure relating to proficiency of a game player who was encouraged to play the video game by the individual promoting the video game. In some embodiments the individual promoting the video game is an individual who streams play of the video game. In some embodiments the game player is determined to have been encouraged to play the video game by purchasing the video game, or a virtual item for or physical merchandise associated with the video game in some embodiments, by way of a link or other method or mechanism provided by the individual who streams play of the video game (or by a stream aggregator which is distributing the stream), or by the game player otherwise identifying the individual promoting the video game.

In some embodiments in accordance with aspects of the invention, a first notification is received that a user is streaming play of a video game, a second notification is received that the user will host or is hosting a gameplay tournament for a video game, play of the gameplay tournament is monitored for the occurrence of one or more preidentified events, and a reward is provided to the user or players in the gameplay tournament. In some embodiments the preidentified event is reaching one or more preidentified achievement levels in the video game. In some embodiments the preidentified event is accomplishing a preidentified task in the video game.

In some embodiments in accordance with aspects of the invention, a notification is received that streaming play of a video game is occurring, the play of the video game is monitored for the occurrence of one or more preidentified events, and a reward is provided to an account of an individual associated with the streaming play upon occurrence of the one or more preidentified events. In some embodiments the preidentified event is reaching one or more preidentified achievement levels in the video game. In some embodiments the preidentified event is accomplishing a preidentified task in the video game.

In some embodiments in accordance with aspects of the invention, a number of viewers who have viewed streaming game play by a game player and/or a number of viewers who are viewing streaming game play by a game player at any given time is monitored. In some embodiments the monitoring is performed by a stream aggregator, in some embodiments the monitoring is performed by a server receiving viewership information from a stream aggregator. In some embodiments the monitoring determines one, some, or all of whether a number of viewers of game play by the game player in total exceeds a predetermined number, whether a number of simultaneous viewers of game play by the game player exceeds a predetermined number, and/or whether a number of simultaneous viewers of game play over a predetermined duration exceeds a predetermined number. In some embodiments, a reward is provided to an account of the game player upon occurrence of a number of viewers of game play by the game player in total exceeding a predetermined number, upon occurrence of a number of simultaneous viewers of game play by the game player exceeding a predetermined number, and/or upon occurrence of a number of simultaneous viewers of game play over a predetermined duration exceeding a predetermined number.

In some embodiments in accordance with aspects of the invention, a notification is received that a game player of a video game has an association with another individual, play of the video game by the game player is monitored for the occurrence of one or more preidentified events, and a reward is provided to an account of the other individual upon occurrence of the one or more preidentified events. In some embodiments the preidentified event is reaching one or more preidentified achievement levels in the video game. In some embodiments the preidentified event is accomplishing a preidentified task in the video game.

Some embodiments in accordance with aspects of the invention provide a method linking video game streamers and video game players, comprising: receiving a notification indicating that a game player of a video game has an association with receiving a notification that streaming play of a video game by a streaming game player is occurring; monitoring the play of the video game for occurrence of one or more preidentified events; and providing a reward to an account of an individual who has an association with the streaming game player responsive to the occurrence of the one or more preidentified events.

These and other aspects of the invention are more fully comprehended upon review of this disclosure.

### BRIEF DESCRIPTION OF THE FIGURES

FIG. 1 is a block diagram of a system of networked gaming platforms and server(s) in accordance with aspects of the invention.

FIG. 2 is a flow diagram of a process for providing awards to game players in video game tournaments hosted by preidentified users.

FIG. 3 is a flow diagram of a process for providing accomplishment-based awards to streaming game players.

FIG. 4 is a flow diagram of a process for providing awards to third parties based on video game accomplishments by a game player.

### DETAILED DESCRIPTION

In accordance with various embodiments, methods and systems are utilized which may encourage video game players to share their video game play exploits with others, encourage others to play those same video games, and to encourage those others to accomplish achievements in video game play. In some embodiments a server is configured to receive notification of occurrence of a video game tournament meeting a predefined criteria, to monitor video game play in the video game tournament for occurrence of preidentified events, and/or to take predefined actions in response to detection of occurrence of the preidentified events. In some embodiments a server is configured to monitor for streaming of video game play of a video game, and to monitor for discrete preidentified events within game play of streamed video game play. In some embodiments a server is configured to receive a notification of a linking between a game player and an individual, to monitor for occurrence of preidentified game play events during play of a video game by the game player, and to effectively provide the individual a notification of occurrence of the preidentified game play events.

In some embodiments the server is configured to link a unique identifier for game players with a financial account associated with the game player. In some embodiments the server is configured to credit the financial account associated with the game player in response to occurrence of a preidentified event during game play by the game player, in some embodiments, and in response to occurrence of a preidentified event during game play by another game player, in some embodiments.

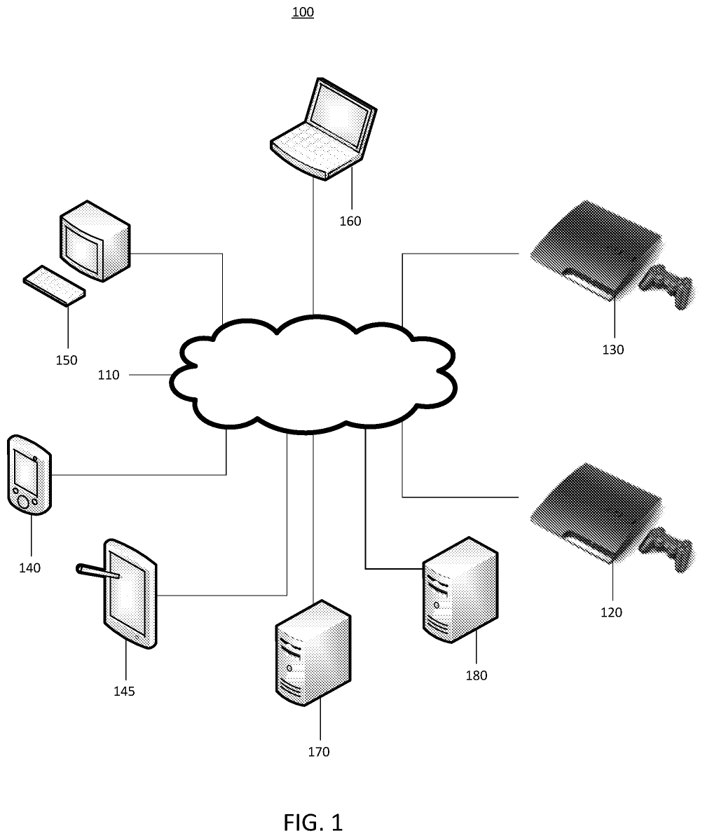

FIG. 1 is a block diagram of a system of networked gaming platforms and server(s) in accordance with aspects of the invention. The system provides for video game play, with monitoring of game play circumstances and/or events, and provision of rewards for video game play accomplishments, with either or both the video game play or the rewards being done in a distributive manner.

The system of FIG. 1 shows a plurality of gaming platforms 120-160. The gaming platforms 120-160 may comprise various compute devices suitable for executing videogames and communicating over communication network 110. In various embodiments the gaming platforms, and the number of gaming platforms, may be different than as shown in the example system of FIG. 1.

In FIG. 1, the system includes a first gaming platform 120 and a second gaming platform 130, which are videogame consoles. Examples of videogame consoles include the Microsoft Xbox, Sony PlayStation, and Nintendo Wii U. In addition to the videogame consoles, gaming platforms may comprise any other suitable compute devices such as mobile devices (e.g., smartphone 140, tablet 145) and personal computers (e.g., desktop computer 150 and laptop computer 160). The gaming platforms 120-160 each have one or more processors, memory, communication circuitry, and associated hardware. Gaming platforms 120-160 may communicate with other gaming platforms 120-160 by sending and receiving data through communication network 110, which may comprise private and public networks. In many embodiments, the communication network comprises the Internet.

The gaming platforms are configured for play of video games. In some embodiments at least one of the gaming platforms is configured, for example by program instructions, to stream play of a video game over the network, for example for viewing by recipients. In some embodiments the gaming platform may stream play of the video game over the network to a stream aggregator, which may in turn provide the stream, or content of the stream to recipients for viewing. In some such embodiments at least some of the gaming platforms are configured for viewing streams of play of video games received over the communications network. In some embodiments, personal computers and/or mobile devices, which may not be configured for play of video games, also may be coupled to the communications network, with such personal computer and/or mobile devices configured for viewing streams of play of video games.

The system further includes one or more servers 170, with only one server box 170 illustrated in FIG. 1. In various embodiments the server monitors for streaming of video games, and for occurrences of events in game play of video games. In some embodiments, the server, or one or more them, may also be a game server. The game server may comprise modules that provide certain services. The modules may include, for example, a matchmaking module, social networking module, data collection module, user profile module, authentication/security module, a communication module, and an online store module.

In some embodiments the server maintains, or has access to, information, for example a database, correlating unique game player identifiers with individuals. In some embodiments the server also maintains, or has access to information correlating individuals and a financial account associated with an individual. The financial account may be a bank account, a paypal account, or some other account. In some embodiments the financial account may simply be a blockchain address (or wallet) associated with the individual.

In some embodiments the server is configured to determine if play of a video game is being streamed, and, if so, an identity of an individual who is playing the video game. In some such embodiments the server is also configured to determine if one or more preidentified events has occurred during gameplay of the streaming video game, and, in response to such a determination, provide a reward to an account associated with the individual.

In some embodiments, the system includes one or more stream aggregation servers 180, with only one server box for a stream aggregation server illustrated in FIG. 1. In various embodiments the stream aggregation servers receive streams of play of video games, and distributes those streams for viewing by recipients. In some embodiments the streams of play of video games include video, and sometimes also audio, of play of a video game. In some embodiments the streams of play of video games may also include audio from a microphone associated with a game player and/or video from a camera as directed by the game player. In some embodiments the streams of play of video games may also include data associated with play of a video game, for example data indicating status of a game character controlled by the game player, data regarding particular actions made or completed by the game character, or other information regarding game actions related to the game character.

In some embodiments the stream aggregation server may perform monitoring mentioned above as being performed by the server 170. In some embodiments the stream aggregation server may provide information as to streaming of video game play by a game player to the server 170. In some embodiments the server 170 may gather information regarding streaming of video game play by the game player by obtaining information from the stream aggregation server, for example information made generally available over the Internet by the stream aggregation server.

In some embodiments the server 170 is configured to determine if play of a video game tournament is a video game tournament for which rewards are offered. The video game tournaments for which rewards are offered may be, for example, video game tournaments hosted by an individual with a history of streaming video game play, in some embodiments. If the video game tournament is a tournament for which rewards are offered, the server may be additionally configured to determine if one or more preidentified events, for example in the way of a video game accomplishment, has occurred during gameplay of the tournament, and, in response to such a determination, provide a reward to an account associated with a game player who has achieved the accomplishment.

In some embodiments the server 170 is configured to determine if play of a video game is by a game player who is associated with another preidentified individual. In some embodiments the other preidentified individual is an individual who has streamed play of the video game. In some embodiments the server may be additionally configured to determine if one or more preidentified events, for example in the way of a video game accomplishment, has occurred during game play by the game player of the video game, and, in response to such a determination, provide a reward to an account associated with the other individual.

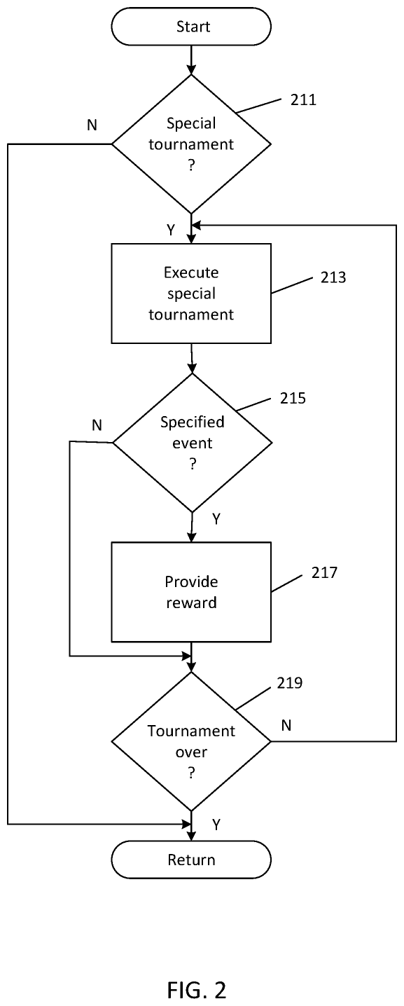

FIG. 2 is a flow diagram of a process for providing awards to game players in video game tournaments hosted by preidentified users. In some embodiments the process is performed by the system of FIG. 1. In some embodiments the process is performed by at least one gaming platform in conjunction with a server, for example a gaming platform and the server of the system of FIG. 1. In some embodiments the process is performed by a server, for example the server of the system of FIG. 1.

In block 211 the process determines if a video game tournament is a video game tournament meeting particular qualifications. In some embodiments the video game tournament is a video game in which multiple video game players play against each other in a video game over a wide area communications network, for example the Internet. In some embodiments the video game tournament comprises a series of rounds of play of the video game.

A video game tournament meeting the particular qualifications may be termed a “special” tournament herein. In some embodiments a special tournament is a tournament hosted by an individual who has streamed play of the video game. In some embodiments a special tournament is a tournament hosted by an individual who has met other predefined criteria. In some embodiments a special tournament is a tournament hosted by an individual who has achieved predefined accomplishments during play of a streamed video game.

If the video game tournament is a special tournament, the process proceeds to block 213. Otherwise the process returns.

In block 213 the process executes or continues to execute the special tournament. In some embodiments a server receives game play information from gaming platforms used by game players playing in the tournament, and provides the game play information received from one gaming platform, or selected portions of the game play information, to others of the gaming platforms. In some embodiments a gaming platform receives game play information from gaming platforms used by game players playing in the tournament, and provides the game play information received from one gaming platform, or selected portions of the game play information, to others of the gaming platforms. In some embodiments the gaming platform is a gaming platform of a game player playing the game. In some embodiments the gaming platform is a gaming platform of a host of the special tournament, who may or may not be a game player playing the game.

In block 215 the process determines if a preidentified event has occurred during play of the video game tournament. In some embodiments the server monitors game play for occurrence of preidentified events, for example by monitoring the game play information which the server receives from gaming platforms used by game players and which, at least part of which, the server distributes to gaming platforms during game play. In some embodiment a gaming platform which is distributing the game play information also distributes the game play information to the server, with the server monitoring the game play information for occurrence of the preidentified events. In some embodiments a gaming platform which is distributing the game play information monitors the game play information for occurrence of the preidentified events. In such embodiments, the gaming platform may also send a notification to a server indicating that the preidentified event has occurred and, in some embodiments information regarding a game player associated with the preidentified event. In some embodiments the preidentifed event is a game player achieving a preidentified game play level. In some embodiments the preidentified event is a specified action with respect to a game controlled game character. In some embodiments the preidentified event is a specified action with respect to a game character controlled by another game player. In some embodiments the specified event is accomplishment of a predetermined number of specified actions.

If the preidentified event has not occurred, the process proceeds to block 219. Otherwise the process goes to block 217.

In block 217 the process provides a reward. In various embodiments provision of the reward is responsive to the determination that a preidentified event has occurred. In some embodiments the process credits a financial account of the game player associated with the preidentified event. In some embodiments the process credits a financial account of the host of the tournament.

In block 219 the process determines if the tournament has completed. If not, the process goes back to operations of block 213 and continues with execution of the tournament. Otherwise the process returns.

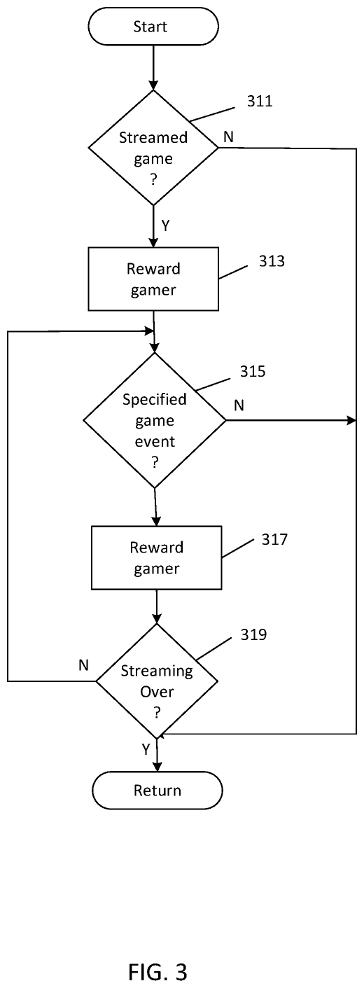

FIG. 3 is a flow diagram of a process for providing accomplishment-based awards to streaming game players. In some embodiments the process is performed by the system of FIG. 1. In some embodiments the process is performed by at least one gaming platform in conjunction with a server, for example a gaming platform and the server of the system of FIG. 1. In some embodiments the process is performed by a server, for example the server of the system of FIG. 1.

In block 311 the process determines if play of a video game is being streamed. In some embodiments the process determines if play of the video game is being streamed by receiving a notification that play of the video game is being streamed. In some embodiments play of the video game is streamed by a gaming platform, and the gaming platform sends the notification to a server. In some embodiments the notification includes information as to identity of an individual who is streaming play of the video game. In some embodiments the information as to identity of the individual is a unique identifier of a game player. In some embodiments the process also determines a number of viewers watching the streaming play of the video game. In some embodiments the process determines the number of viewers by determining a number of devices which have requested to view the streaming play of the video game. For some embodiments the process determines, on a periodic basis, for example every second, every few seconds, or every minute, a number of devices to which streaming play of the video game is being sent. In some embodiments the process determines a number of devices to which streaming play of the video game is being sent over predetermined time periods.

If play of the video game is being streamed, the process proceeds to block 313, otherwise the process returns.

In block 313 the process provides a reward to the individual who is streaming play of the video game. In various embodiments provision of the reward is responsive to the determination that streaming of play of the video game has occurred. In some embodiments the process credits a financial account of the individual who is streaming play of the video game. In some embodiments a reward is provided, or in some embodiments an additional reward is provided, to the individual if a number of viewers is over a predetermined number, or over a predetermined number for a predetermined duration of time.

In block 315 the process determines if a preidentified event has occurred during streaming of play of the video game. In some embodiments the server receives and monitors game play of streaming video game play for occurrence of preidentified events. In some such embodiments the game platform providing streaming of video game play also provides game play state information to the server, and the server monitors the game play state information for the occurrence of the preidentified events. In some embodiments the gaming platform which is streaming play of the video game monitors game play information for occurrence of the preidentified events. In such embodiments, the gaming platform may also send a notification to a server indicating that the preidentified event has occurred and, in some embodiments information regarding a game player associated with the preidentified event. In some embodiments the preidentifed event is a game player achieving a preidentified game play level. In some embodiments the preidentified event is a specified action with respect to a game controlled game character. In some embodiments the preidentified event is a specified action with respect to a game character controlled by another game player. In some embodiments the specified event is accomplishment of a predetermined number of specified actions. In some embodiments the specified event is an event selected by the individual who is streaming play of the video game. In some such embodiments the individual may be presented a list of preidentified events to select from, for example by way of use of a pull-down menu.

If the preidentified event has not occurred, the process proceeds to block 319. Otherwise the process goes to block 317. In block 317 the process provides a reward to the individual who is streaming play of the video game, and/or individuals who are viewing streaming of play of the video game. In various embodiments provision of the reward is responsive to the determination that the preidentified event has occurred during streaming of play of the video game. In some embodiments the process credits a financial account of the individual who is streaming play of the video game. In some embodiments the process instead or in addition rewards individuals viewing the streaming of play of the video game, and may for example credit financial accounts of such individuals. In some embodiments the individuals who are viewing streaming play of the video game are those individuals viewing the streaming play as the preidentified event occurs. In some embodiments the individuals may also include individuals who view the occurrence of the event at a later time, with the individuals for example viewing a stored version of the streaming play, with the stored version for example stored as a part of video-on-demand capability, for example as provided by a stream aggregator. In addition, in some embodiments occurrence of the specified event may also trigger presentation of an opportunity, time limited in some embodiments, for viewers of the stream to purchase a particular item, possibly at a discounted price.

In this regard, in some embodiments a streamer may be rewarded for game play events during video game play by those associated with the streamer, in some embodiments regardless of whether the video game play by those associated with the streamer is itself being streamed. In some embodiments, for example, the server may maintain information indicating which individuals have purchased video games or other items in association with the streamer (or who have viewed streaming video game play of the streamer in some embodiments), with such individuals being considered followers of the streamer. In some embodiments, for example, game play information of video game play by followers of a streamer may be monitored for occurrence of a predetermined game play event, for example as discussed above with respect to block 315. Upon occurrence of the predetermined game play event, the process may provide a reward to the streamer, for example as discussed with respect to block 317.

In block 319 the process determines if streaming of play of the video game has completed. If not, the process goes back to block 315 and continues to monitor for the occurrence of preidentified game events. Otherwise the process returns.

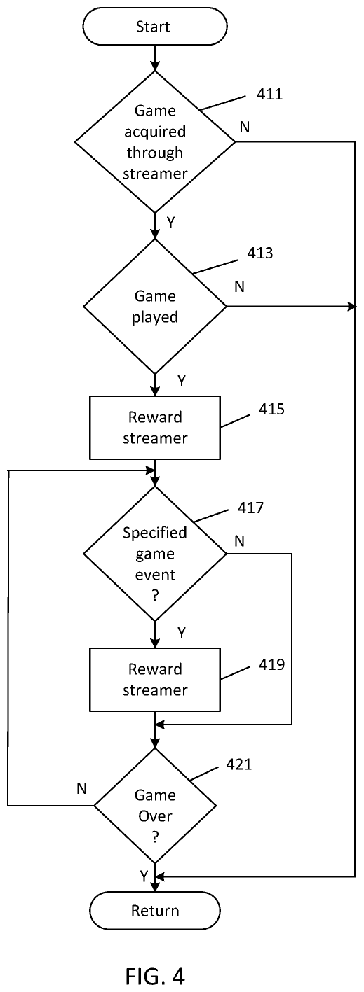

FIG. 4 is a flow diagram of a process for providing awards to third parties based on video game accomplishments by a game player. In some embodiments the process is performed by the system of FIG. 1. In some embodiments the process is performed by at least one gaming platform in conjunction with a server, for example a gaming platform and the server of the system of FIG. 1. In some embodiments the process is performed by a server, for example the server of the system of FIG. 1.

In block 411 the process determines if a video game or in some embodiments downloadable content (DLC) or game items (e.g. microtransaction items (MTX)) for the video game has been purchased through an association with an individual who streams play of video games, who may be termed a streamer. In some embodiments the process determines if the video game (or DLC or MTX) has been purchased through a link on a web page maintained by the individual who streams play of video games. In some embodiments the process determines if the video game has been purchased through a link on a web page, or a selectable icon on a viewing screen, maintained or provided by a stream aggregator which streams play of a video game by the streamer. In some embodiments the process determines if, at or about the time of purchase, a purchaser of the video game (or DLC or MTX) identifies the individual who streams play of video games as a reason for purchase of the video game. In some embodiments a server receives a notification of indicating a purchase of the video game (or DLC or MTX) through an association with the individual who streams play of video games, and an identifier identifying the purchaser of the video game. In some embodiments the identifier is a unique identifier of a game player, the game player being either the purchaser or an individual identified by the purchaser as one who will be playing the purchased game.

In block 413 the process determines if the video game purchased through an association with the streamer has been played. If so, the process rewards the streamer in block 415. If not, the process returns. In some embodiments, in block 415 provision of the reward is responsive to the determination that play of the video game (or DLC or MTX) purchased through an association with the streamer has occurred. In some embodiments the process credits a financial account of the streamer.

In block 417 the process determines if a preidentified event has occurred during play of the video game through an association with the streamer. In some embodiments a server receives and monitors game play information for play of the video game play for occurrence of preidentified events. In some such embodiments the gaming platform provides game play state information to the server, and the server monitors the game play state information for the occurrence of the preidentified events. In some embodiments the gaming platform which is providing for play of the video game monitors game play information for occurrence of the preidentified events. In such embodiments, the gaming platform may also send a notification to a server indicating that the preidentified event has occurred and, in some embodiments information regarding the game player or the streamer. In some embodiments the preidentifed event is a game player achieving a preidentified game play level. In some embodiments the preidentified event is a specified action with respect to a game controlled game character. In some embodiments the preidentified event is a specified action with respect to a game character controlled by another game player. In some embodiments the specified event is accomplishment of a predetermined number of specified actions.

In block 419 the process provides a reward to the streamer. In various embodiments provision of the reward is responsive to the determination that the preidentified event has occurred during play of the video game purchased through an association with the streamer. In some embodiments the process credits a financial account of the streamer.

In block 421 the process determines if play of the video game is over. If not the process goes back to block 417 and continues to monitor for preidentifed events. Otherwise the process returns.

Although the invention has been discussed with respect to various embodiments, it should be recognized that the invention comprises the novel and non-obvious claims supported by this disclosure.

1.-5. (canceled)

6. A method of tracking streaming of video game play, comprising:
receiving, by a server, a notification from a gaming platform that streaming, by the gaming platform, of play of a video game on the gaming platform, in which play of the video game is streamed over a network for viewing by viewers, including viewing by at least some viewers on compute devices not configured for play of the video game, is occurring;
monitoring, by the server, the play of the video game for occurrence of one or more preidentified events in the play of the video game; and
providing, by the server, a reward to an account of an individual associated with the streaming of the play of the video game, responsive to the occurrence of the one or more preidentified events in the play of the video game, the individual associated with the streaming of play of the video game being an individual viewing the streaming of play of the video game on a one of the compute devices not configured for play of the video game.

7. The method of claim 6, wherein monitoring the play of the video game comprises receiving, from the gaming platform and over a network, game state information for play of the video game.

8. The method of claim 6, wherein monitoring the play of the video game comprises receiving, from the gaming platform and over a network, a notification of occurrence of a preidentified event of the one or more preidentified events.

9. The method of claim 6, wherein the one or more preidentified events include attainment of one or more preidentified achievement levels in the video game.

10. The method of claim 6, wherein the one or more preidentified events include accomplishment of a preidentified task in the video game.

11. A method linking video game streamers and video game players, comprising:
receiving, by a server and from a gaming platform, a notification that an individual streams play of a video game for viewing by viewers, including viewing by viewers using compute devices not configured for play of the video game, the video game being played on the gaming platform;
receiving a notification that a game player of the video game has an association with the individual;
monitoring, by the server, play of the video game by the game player for the occurrence of one or more preidentified events in play of the video game; and
providing, by the server, a reward to an account of the other individual upon occurrence of the one or more preidentified events.

12. The method of claim 11, wherein the notification that the game player has an association with the individual is a notification that the game player has purchased a product related to the video game using a link associated with streaming of play of the video game by the individual.

13. The method of claim 12, wherein the link is provided by a stream aggregator providing for transmission of streaming game play of the video game to viewers.

14. The method of claim 11, wherein the preidentified event is attainment of a preidentified achievement level in the video game.

15. The method of claim 11, wherein the preidentified event is accomplishment of a preidentified task in the video game.

16. (canceled)

17. The method of claim 11, wherein the association is based on one or more of the game player viewing the streaming play of the video game by the individual, the game player purchasing the video game through a link associated with the streaming play of the video game by the individual, or the game player purchasing a video game related item through a link associated with streaming of play of the video game by the individual.

18. The method of claim 11, wherein at least one of the one or more preidentified events is an event selected by the individual.
